(19) United States
(12) Patent Application Publication
(10) Pub. No.: US 2019/0191267 A1
(43) Pub. Date: Jun. 20, 2019

(54) METHOD AND APPARATUS FOR WIRELESS VEHICLE COMMUNICATION

(71) Applicant: GM GLOBAL TECHNOLOGY OPERATIONS LLC, DETROIT, MI (US)

(72) Inventors: William H Wang, Troy, MI (US); Eray Yasan, Canton, MI (US); Timothy J Talty, Beverly Hills, MI (US); Daniel G Hool, Warren, MI (US); Leonard C Nieman, Warren, MI (US); Duane S Carper, Davison, MI (US); James H Schaffner, Chatsworth, CA (US); Hyok Jae Song, Oak Park, CA (US)

(21) Appl. No.: 15/842,322

(22) Filed: Dec. 14, 2017

(51) Int. Cl. H04W 4/00; B60K 35/00; H04B 5/00; H04W 84/18

(52) U.S. Cl. CPC H04W 4/008; B60K 35/00; H04W 84/18; H04W 76/023; H04B 5/0025

(57) ABSTRACT

The present application generally relates to an apparatus for communicating between a user device and a vehicle infotainment system. In particular, the system includes a near field antenna with near transparent conductors applied to a video display image such that the near field antenna is constructed from nearly transparent or color matched conductors and wherein the antenna is applied to the video display surface.

### BACKGROUND

The present disclosure relates generally to onboard electronic systems for providing wireless communication capabilities to a motor vehicle. More specifically, aspects of this disclosure relate to systems, methods and devices for establishing a wireless communication session between a smartphone, tablet computer, or other portable electronic device and a motor vehicle using Near Field Communication protocols.

### BACKGROUND INFORMATION

Current production motor vehicles are often equipped or retrofit with various types of onboard communication devices for transferring information to and from vehicle occupants. In certain automotive applications, for example, passenger cars are outfitted with an instrument cluster that communicates information to the driver regarding such things as vehicle speed, engine speed, fuel level, engine conditions, and other vehicle-related data. In addition to the instrument cluster, most automobiles include as standard equipment an onboard audio system that operates alone or in conjunction with peripheral hardware to play music, output navigation instructions, receive voice commands, or provide other audio related functionality. Some motor vehicles are now equipped with a graphical user interface, such as a touchscreen video display panel, that is positioned in a center stack of the passenger compartment and is operable to receive user inputs and display image, text, and video-based content. In-vehicle audiovisual (AV) hardware that delivers entertainment and informational content is collectively referred to in the art as an integrated “infotainment” system.

Onboard vehicle devices may communicate content that is based, for example, on data received from a local device, such as a networked vehicle controller, smartphone, laptop, or digital audio file player, as well as data received from a remote device, such as a radio transmitter, GPS navigation transceiver, or satellite broadcast service. Some devices are even able to receive data from a distributed computer network—the most ubiquitous being the global Internet—over a wireless fidelity (WiFi) system, cellular network, or other wireless data exchange technology. Content that is output based on data received over a wireless network may include, for example, video (e.g., streaming television, movies, video clips, etc.), audio (e.g., Internet radio, podcasts, audio books, etc.), print media, social media, mobile phone media, and innumerable other types of information. Many vehicles now support seamless integration of a smartphone with the vehicles' infotainment systems, which allows occupants to access email, the World Wide Web, and, of course, use as a phone.

Wireless communication capabilities have become increasingly common in modern vehicles, enabling in-vehicle devices to interact with off-board devices in a variety of ways. Among the available wireless technologies, Near Field Communication (NFC) is a standardized set of communication protocols that enables two electronic devices to establish an encrypted communication channel through electromagnetic induction by bringing them within a predefined distance of each other, typically 20 cm (7.9 in) or less. There are two primary types of NFC-enabled devices: a passive device, such as an NFC tag, contains information that other devices can read/write but cannot itself read information; and an active device, such as a smartphone, that can store, read, write and send information. Whereas cellular technologies employ long-range radio signals to transmit data multiple miles from the confines of a host vehicle, NFC signal range is very limited, making it infeasible for NFC signals to be intercepted or manipulated by a device which is not physically located in very close proximity to the host vehicle. A problem exists in that newer sleek look center console stacks and integrated clusters make packaging of traditional NFC antennas difficult. It would be desirable to overcome these limitations.

The above information disclosed in this background section is only for enhancement of understanding of the background of the invention and therefore it may contain information that does not form the prior art that is already known in this country to a person of ordinary skill in the art.

### SUMMARY

Disclosed herein are NFC-enabled communication systems and related control logic for provisioning wireless vehicle communication, methods for making and methods for operating such systems, and motor vehicles equipped with an onboard NFC-enabled device for short-range communication with off-board NFC-enabled devices. By way of example, and not limitation, there is presented an automobile with NFC communication.

In accordance with an aspect of the present invention, an apparatus comprising a video display having a front side and a back side wherein the backside has a metallic surface and the front side is operative to display a video information, a video controller coupled to the video display for controlling the display of the video information, an antenna mounted on the front side of the video display wherein the antenna is constructed from semitransparent conductors such that the video information is visible through the antenna, and an access controller coupled to the antenna and the video controller, wherein the access controller is operative to generate an authentication control signal in response to an authentication signal received via the antenna from a device operative to communicate with the video controller in response to the authentication control signal.

In accordance with another aspect of the present invention an apparatus comprising a video display having a front portion for displaying a visual information, a near field antenna for receiving an authentication signal from a user device wherein the near field antenna is mounted on the front portion of the video display and wherein the near field antenna is fabricated from nearly transparent conductive material, and a processor for receiving the authentication signal from the near field antenna and for providing the visual information in response to the authentication signal.

In accordance with another aspect of the present invention an apparatus for wireless communications in a vehicle comprising a video display having a display portion for displaying a visual information, a processor for generating the visual information in response to am authentication signal, and a near field antenna mounted over the display portion of the video display wherein the near field antenna includes a pattern of conductors configured such that the near field antenna is transparent, the near field antenna being operative to receive the authentication signal from a user device and couple the authentication signal to the processor.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an automotive near field communications suffering from the problem addressed by the presently disclosed system.

FIG. 2 shows an exemplary environment for NFC in an automobile according to an exemplary embodiment.

FIG. 3 shows an exemplary environment for NFC in an automobile according to another exemplary embodiment.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the algorithms, software and systems of the present invention have particular application for use on a vehicle. However, as will be appreciated by those skilled in the art, the invention may have other applications.

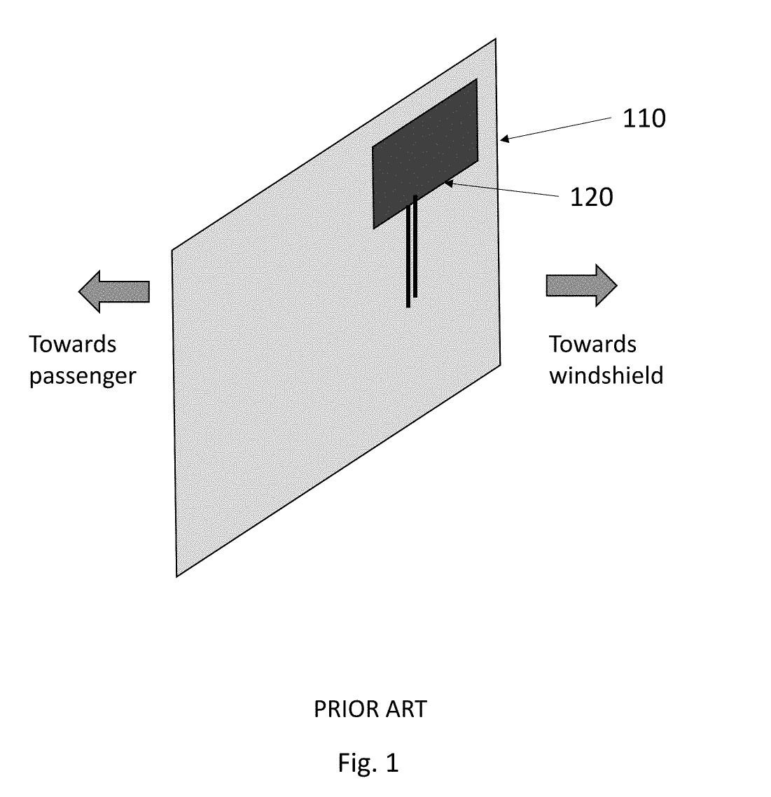

Turning now to FIG. 1, an automotive near field communications suffering from the problem addressed by the presently disclosed system is shown. The near field antenna 120 is mounted to an integrated center stack 110. The integrated center stack 110 has a display portion, such as a video screen, that covers much or all of the integrated center stack 110. Thus, it is desirable to not cover the video portions of the integrated center stack 110 in order to not block the display from the driver. The integrated center stack 110 in this example is made of a polycarbonate material on the front, passenger facing side, and a magnesium plate, on the back, windshield facing side. The video portions of the integrated center stack will have, for example, an LCD, LED, or OLED display panel or the like which commonly has a metallic backplane covering the backside of the display panel. In this configuration, the only place to mount a conventional NFC antenna 120 is on the rear of the integrated center stack 110. This limits the performance of the NFC antenna 120 in the direction of the passenger, which is the desired direction. In this configuration, most of the energy from the NFC antenna 120 is reflected by the magnesium plate back towards the windshield of the vehicle.

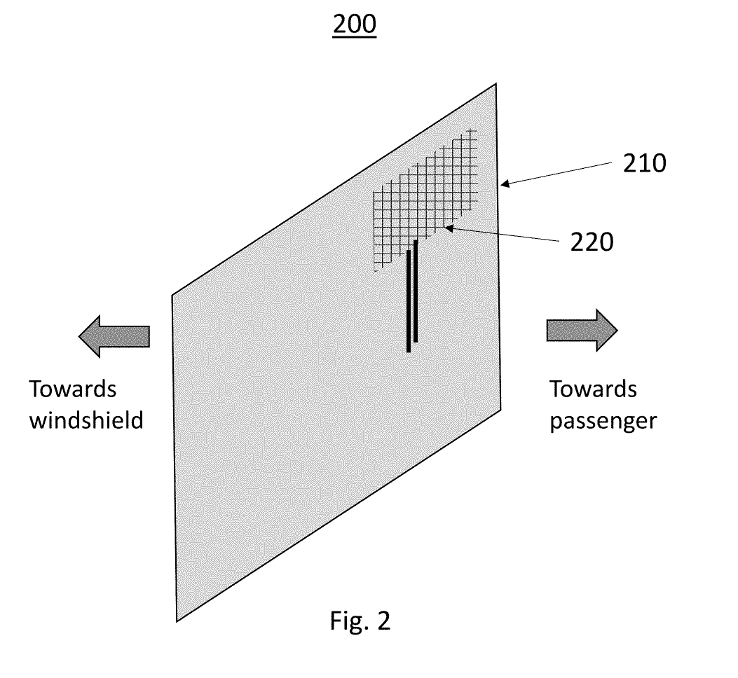

Turning now to FIG. 2 an exemplary environment 200 for a near field communications (NFC) antenna according to an exemplary embodiment is shown. In this exemplary embodiment, a nearly transparent NFC antenna 210 is mounted on the polycarbonate surface of the integrated center stack 210. The NFC antenna 210 would be constructed out of very thin conductors thereby making them virtually transparent to a viewer of the integrated center stack 210. In this exemplary embodiment, half of the transmitted energy is radiated towards the passenger, while the other half is reflected from the magnesium plate and reflected back towards the NFC antenna 220 and the passenger. The NFC antenna may be mounted in the display area, or over the “black out” edges of integrated center stack where there are no elements to be displayed. In this exemplary embodiment, the conductors may be constructed out of nearly transparent or color matched conductors where the color matching is made to the non-display portions of the integrated center stack.

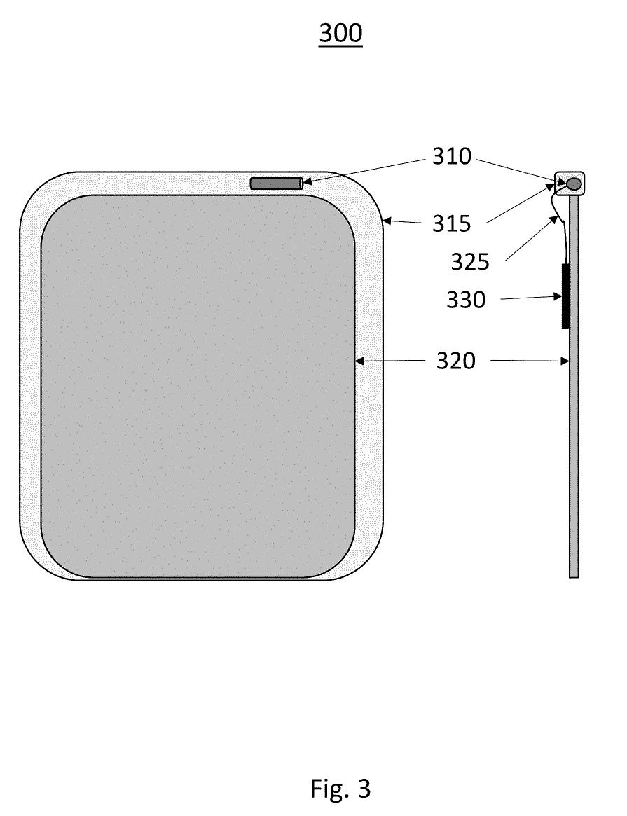

Turning now to FIG. 3, an exemplary environment 300 for NFC in an automobile according to another exemplary embodiment is shown. In this exemplary embodiment, the NFC antenna 310 is configured as a wire wrapped ferrite rod shaped to be concealed behind a trim piece 315 surrounding the integrated center stack 320. The trim piece 315 is fabricated from a nonconductive material and therefore would permit the antenna 310 to radiate freely. The NFC ferrite rod antenna 310 can be place on trim edges behind plastic, wood, or fabric trim pieces 315. Since the magnetic field wraps around the coil, the energy from the coil will be directed towards the passenger side.

The exemplary embodiment wherein the NFC antenna 310 is a wire wrapped ferrite rod facilitates mounting the NFC antenna at a location proximate to the integrated center stack 320 with display and touch sensitive surfaces. The NFC antenna 310 can be coupled to circuitry 330, such as a video processor, authentication processor, or the like, behind the integrated center stack 320 by wires running behind the integrated center stack 320 or within non display areas of the integrated center stack 320.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. An apparatus comprising:
a video display having a front side and a back side wherein the back side has a metallic surface and the front side is operative to display a video information;
a video controller mounted to the back side of the video display wherein the video controller is coupled to the video display for controlling the display of the video information;
an antenna mounted on the front side of the video display wherein the antenna is constructed from semitransparent conductors such that the video information is visible through the antenna; and
an access controller mounted to the back side of the video display wherein the access controller is coupled to the antenna and the video controller, wherein the access controller is operative to generate an authentication control signal in response to an authentication signal received via the antenna from a device operative to communicate with the video controller in response to the authentication control signal.

2. The apparatus of claim 1 wherein the antenna is a microstrip antenna.

3. The apparatus of claim 1 wherein the antenna is mounted to a non-display portion of the video display and wherein the antenna is color matched to the non-display portion.

4. The apparatus of claim 1 wherein the video display is a part of an integrated center stack in a vehicle.

5. The apparatus of claim 1 wherein the video display is part of an infotainment system in a vehicle.

6. The apparatus of claim 1 wherein the authentication control signal is used to pair a cellphone with the apparatus.

7. The apparatus of claim 1 wherein the antenna is a near field communications antenna.

8. An apparatus comprising:
a video display having a front portion for displaying a visual information and a back side having a metallic surface;
a near field antenna for receiving an authentication signal from a user device wherein the near field antenna is mounted on the front portion of the video display and wherein the near field antenna is fabricated from nearly transparent conductive material; and
a processor for receiving the authentication signal from the near field antenna and for providing the visual information in response to the authentication signal, wherein the processor is mounted to the back side of the video display.

9. The apparatus of claim 8 wherein the near field antenna is a microstrip antenna.

10. The apparatus of claim 8 wherein the near field antenna is mounted to a non-display portion of the video display and wherein the near field antenna is color matched to the non-display portion.

11. The apparatus of claim 8 wherein the video display is a part of an integrated center stack in a vehicle.

12. The apparatus of claim 8 wherein the video display is part of an infotainment system in a vehicle.

13. The apparatus of claim 8 wherein the authentication signal is used to pair a cellphone with the apparatus.

14. An apparatus for wireless communications in a vehicle comprising:
a video display having a display portion for displaying a visual information and a back side having a metallic surface;
a processor mounted to the back side of the video display for generating the visual information in response to am authentication signal; and
a near field antenna mounted over the display portion of the video display wherein the near field antenna includes a pattern of conductors configured such that the near field antenna is transparent, the near field antenna being operative to receive the authentication signal from a user device and couple the authentication signal to the processor.

15. The apparatus of claim 14 wherein the near field antenna is a microstrip antenna.

16. The apparatus of claim 14 wherein the near field antenna is partially mounted to a non-display portion of the video display and wherein a portion of the near field antenna overlaps the non-display portion is color matched to the non-display portion.

17. The apparatus of claim 14 wherein the video display is a part of an integrated center stack in a vehicle.

18. The apparatus of claim 14 wherein the video display is part of an infotainment system in a vehicle.

19. The apparatus of claim 14 wherein the authentication control signal is used to pair a cellphone with the apparatus.

20. The apparatus of claim 14 wherein the authentication signal is used to enable a Bluetooth connection between the apparatus and the user device.
